(19) United States
(12) Patent Application Publication
(10) Pub. No.: US 2013/0081330 A1
(43) Pub. Date: Apr. 4, 2013

(54) AIRCRAFT INTERIOR DOOR ASSEMBLY

(71) Applicants: Clarence M. Ivester, Arlington, WA (US); Sylvio A.C. Bravetti, Brier, WA (US)

(72) Inventors: Clarence M. Ivester, Arlington, WA (US); Sylvio A.C. Bravetti, Brier, WA (US)

(73) Assignee: B/E Aerospace, Inc., Wellington, FL (US)

(21) Appl. No.: 13/588,083

(22) Filed: Aug. 17, 2012

Related U.S. Application Data
(60) Provisional application No. 61/524,607, filed on Aug. 17, 2011.

(51) Int. Cl. B64C 1/14; E05D 15/58; B64D 11/02

(52) U.S. Cl. CPC B64C 1/1461; B64D 11/02; E05D 15/581
USPC 49/211

(57) ABSTRACT

An aircraft interior door assembly, such as for a lavatory, including a door panel configured to simultaneously pivot and translate within its opening, a first pair of linear door guides running parallel to the door opening for guiding pivoting and translational movement of the door panel, the door panel pivotally attached to the first pair of linear door guides mid-span along its length, and a second pair of linear door guides running along an adjacent wall at an angle to the door opening for guiding an attached side of the door panel along the adjacent wall.

### CROSS-REFERENCE TO RELATED APPLICATION

This application claims priority to U.S. Provisional Application No. 61/524,607 filed Aug. 17, 2011, the entirety of which is incorporated by reference herein.

### TECHNICAL FIELD AND BACKGROUND OF THE INVENTION

Aircraft interiors are typically fitted with swinging or folding-style doors to close off the entrance to rooms such as lavatories, closets, galleys, crew rest spaces and cockpits. Swinging-style doors typically include a slab door hinged along one side that opens to either the interior or exterior of the room. Swinging doors that open to the interior require clearance within the room for the entire width of the door, and thus often limit the width of the door, block ingress into or egress from the room, and dictate the arrangement of fixtures and furniture within the room. Swinging doors that open to the exterior of the room block the aisle, impede passenger and crew motion, and collide with opposing doors when open.

Folding-style doors typically include multiple panels hinged together along their sides that fold together and slide along a track along a door opening. Although folding-type doors require less interior and exterior clearance than swinging doors when open due their lesser folded width, folding doors often times simultaneously require lesser amounts of both interior and exterior clearance when open, and are often difficult to operate because the door needs to simultaneously slide and fold in use.

To overcome the disadvantages of conventional door designs for use in aircraft interiors, what is needed is a door structure that is easy to operate, does not interfere with the space needed by the crew and passengers during opening and closing, does not impede ingress or egress from the room, and that does not dictate the placement of amenities, fixtures and furniture within the room.

### BRIEF SUMMARY OF THE INVENTION

In one aspect, an interior door assembly for a passenger aircraft is provided herein.

In another aspect, an interior door assembly for an aircraft lavatory is provided herein.

In another aspect, the door simultaneously pivots and translates in use relative to a floor guide in the door opening.

In another aspect, the door is cooperatively supported and guided during opening and closing by a floor guide and a wall guide on an adjacent wall arranged at an angle to the floor guide.

In another aspect, the door assembly includes two pairs of linear guides, the first pair of guides running parallel to the door opening and the second pair of guides running along an adjacent wall substantially perpendicular to the door opening

In another aspect, one member of each pair of guides is located at or near the top of the door, and the second member of each pair of guides is located at or near the bottom of the door.

In another aspect, the door includes a single slab that is hinged along one side to the pair of wall guides for guiding movement of the hinged side, and pivots about a vertical pivot axis that translates along the pair of guides in the door opening.

In another aspect, the vertical pivot axis of the door is mid-span along the length of the door.

In another aspect, the hinged side of the door moves inward into the room when the door is opened and the free end of the door moves in the direction of the adjacent wall carrying the wall guides.

In another aspect, the floor guide of the pair of guides in the door opening is configured for serviceability, durability and high resistance to dirt.

In another aspect, the door assembly is spring-loaded to produce self-opening and self closing assistance.

In another aspect, the door includes a latch and a locking mechanism

In another aspect, maximum protrusion of the door from the occurs in the fully open position.

In another aspect, the door is an aircraft lavatory door for use with a avatory with an adjacent attendant wall arranged substantially perpendicular thereto, wherein the door in the fully open position does not protrude beyond the face of the attendant wall.

In another aspect, the free end of the door does not enter the room in use.

In another aspect, the door is pivotally attached to and suspended from an upper door frame guide of the pair of guides running parallel to the door opening.

In another aspect, one or more of the guides of the first and second pairs of guides are embedded within lavatory panels.

In another aspect, sliding elements of the door assembly are preferably maintenance-free, self lubricating and have a low coefficient of friction for smooth operation.

To achieve the foregoing and other aspects and advantages, in one embodiment an aircraft interior door assembly is provided herein including a door panel configured to simultaneously pivot and translate within a door opening, a first pair of linear door guides running parallel to the door opening for guiding pivoting and translational movement of the door panel relative to the door opening, the door panel being pivotally attached to the first pair of linear door guides mid-span along the length of the door panel, and a second pair of linear door guides running along an adjacent wall at an angle to the door opening for guiding an attached side of the door panel along the adjacent wall.

According to a further embodiment, one linear door guide of each of the first and second pairs of linear door guides is located at or near the top of the door panel, and the other linear door guide of the first and second pairs of linear door guides is located at or near the bottom of the door panel. Each of the first and second pairs of linear door guides may be in vertically spaced apart alignment.

According to a further embodiment, at least one of the linear door guides of the first and second pairs of linear door guides are embedded within an interior wall panel.

According to a further embodiment, pivot points at the top and bottom of the door panel with the first pair of linear door guides are in vertical alignment.

According to a further embodiment, each of the linear door guides of each of the first and second pairs of linear door guides includes a door panel attachment member that travels linearly within a guide track.

According to a further embodiment, the adjacent wall is perpendicular to the door opening such that the first pair of linear door guides are arranged perpendicular to the second pair of linear door guides.

According to a further embodiment, the door opening is a door opening of an aircraft lavatory and the adjacent wall is an attendant wall, and wherein a free side of the door panel protrudes outward beyond the door opening but does not protrude outward beyond a face of the attendant wall when the door panel is fully open.

According to another embodiment of the invention, an aircraft lavatory accessible through a door opening is provided herein, the door opening including a door assembly including a door panel configured to simultaneously pivot and translate within the door opening, a first pair of linear door guides running parallel to the door opening for guiding pivoting and translational movement of the door panel within the door opening, the door panel being pivotally attached to the first pair of linear door guides mid-span along the length of the door panel, and a second pair of linear door guides running along a lavatory wall adjacent the door opening and at an angle thereto for guiding an attached side of the door panel along the lavatory wall within the lavatory.

In a further embodiment, one linear door guide of each of the first and second pairs of linear door guides is located at or near the top of the door panel, and the other linear door guide of the first and second pairs of linear door guides is located at or near the bottom of the door panel.

According to another embodiment of the invention, an aircraft interior door assembly is provided herein including a door panel configured to simultaneously pivot and translate within its door opening, a first pair of linear door guides running parallel to the door opening for guiding pivoting and translational movement of the door panel, the door panel being pivotally attached to the first pair of linear door guides mid-span along its length, and a second pair of linear door guides running along an adjacent wall perpendicular to the door opening, the second pair of linear door guides guiding movement of a side of the door panel attached to the second pair of linear door guides along the adjacent wall.

In a further embodiment, one linear door guide of each of the first and second pairs of linear door guides is located at or near the top of the door panel, and the other linear door guide of the first and second pairs of linear door guides is located at or near the bottom of the door panel.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the door structure are understood when the following detailed description of the invention is read with reference to the accompanying drawings, in which:

FIG. 1 illustrates a door assembly according to an embodiment of the invention;

FIG. 2 is an overhead plan view of an aircraft lavatory fitted with the door assembly and showing the door movement;

FIG. 3 is a detailed view of a lower door guide of a pair of guides aligned parallel to the door opening;

FIG. 4 is a detailed view of a lower wall guide of a pair of wall guides running along an adjacent wall substantially perpendicular to the door opening;

FIG. 5 is a detailed view showing the protrusion of the free edge of the door in the open position with respect to a face of an adjacent attendant wall;

FIG. 6 is a detailed view of the top of the door showing pivoting attachment of the door guide and upper guide of the pair of guides running parallel to the door opening;

FIG. 7 is a detailed view of the upper guide running parallel to the door opening an embedded within a lavatory panel; and

FIG. 8 is a sectional view through the cover of the lower door opening guide.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

Referring to the figures, a door assembly including a single door panel configured to open with minimal intrusion into a room is provided herein. The door assembly is suitable for use in a passenger aircraft interior, for example, as a lavatory door, crew quarters door, galley door, closet door or cockpit door, among other doors. The door assembly is shown throughout the figures as a lavatory door by way of example only. The door assembly can be used in any application that can benefit from an easy to use door that requires minimal internal and external clearance when opened. The door assembly can be used in any application including an adjacent wall or other structure arranged at an angle to the door opening, and preferably perpendicular to the door opening.

The preferred embodiment of the door assembly according to the present invention is shown throughout the figures at reference numeral 10. The door assembly 10 generally includes a single door panel 12 configured to simultaneously pivot and translate relative to the door opening when opened and closed. The movement of the door panel 12 is cooperatively guided by a plurality of linear door guides located in the door frame above and below the door panel, and to one side of the door panel 12 along an adjacent wall 18 at an angle to the door opening, preferably perpendicular to the door opening. The adjacent wall 18 may be an interior lavatory wall.

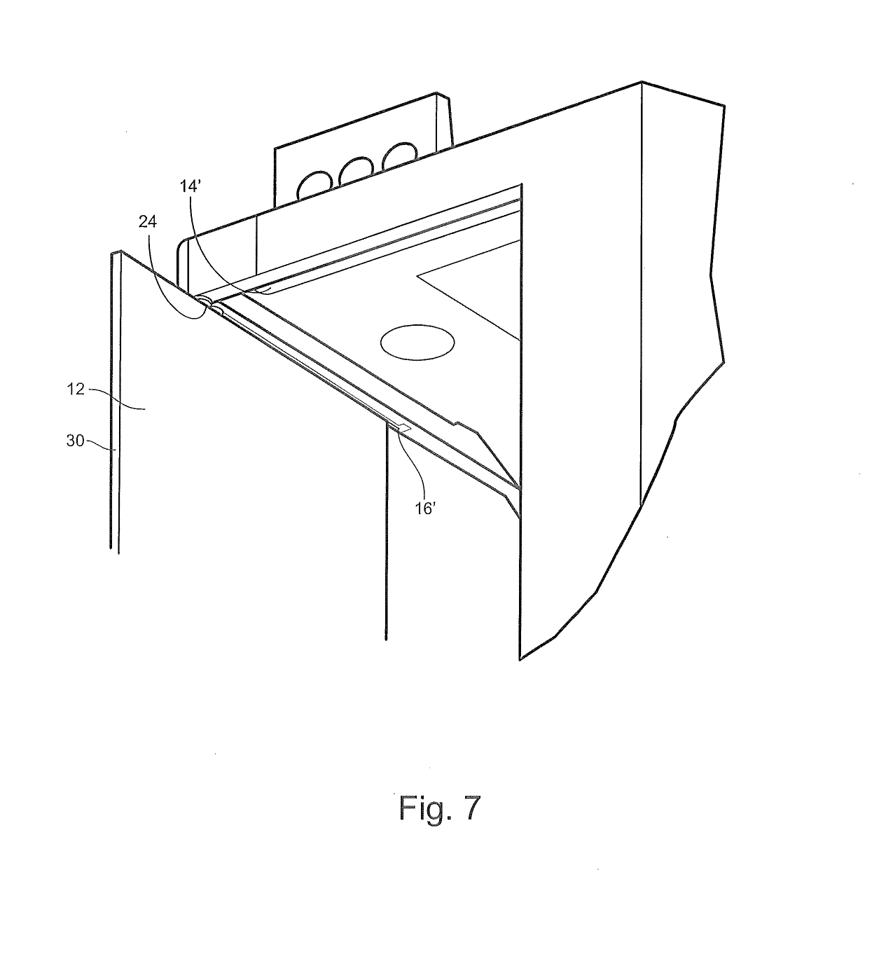

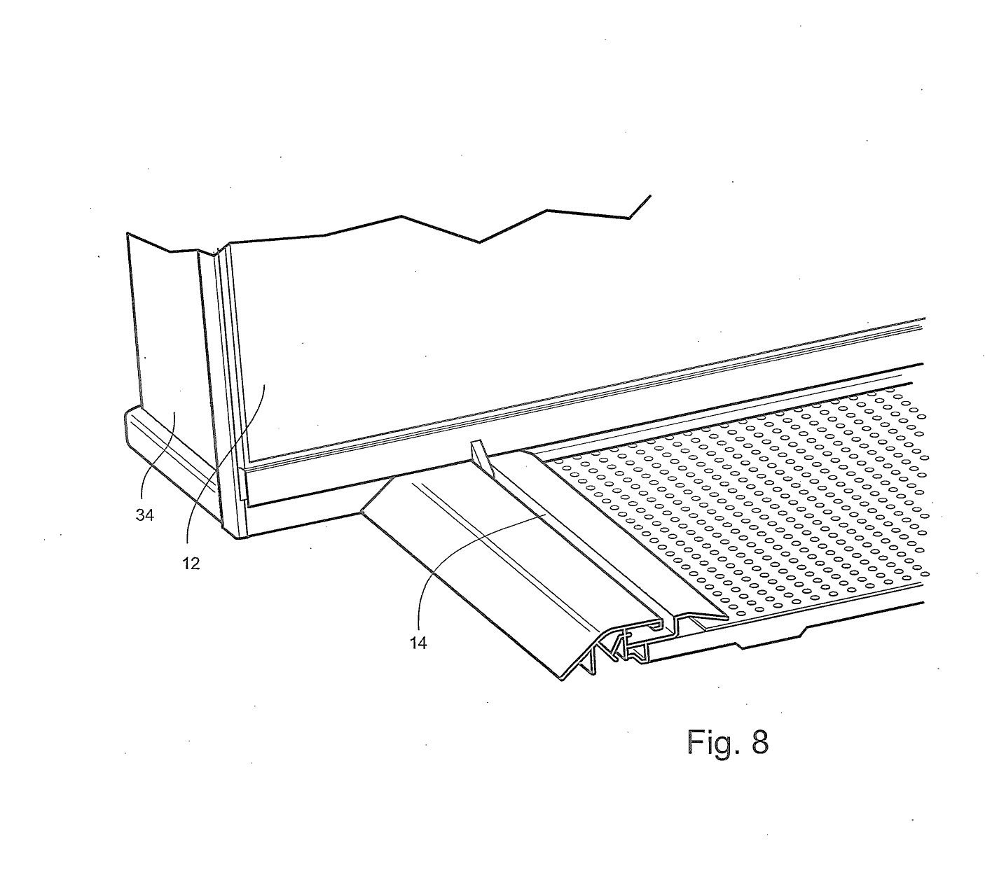

The plurality of door guides for guiding simultaneous pivoting and translational movement of the door panel 12 include a first pair of linear door guides 14, 14′ running parallel to the door opening, and a second pair of linear door guides 16, 16′ arranged along the adjacent wall 18 at an angle to the door opening and the first pair of linear door guides 14, 14′. The first pair of linear door guides 14, 14′ includes a lower door guide 14 arranged parallel to the door opening such as located along the threshold, and an upper door guide 14′ located in the top of the door frame parallel to the lower door guide 14. The lower and upper door guides 14, 14′ are in spaced vertical alignment and provide substantially the same length of travel of the door panel 12. The door panel 12 may rest and pivot upon a pin or pinion in at least one of the lower and upper door guides 14, 14′, and can include a pair of rollers 24 at the top of the door panel 12 between which the upper door guide 14′ is trapped and along which the rollers 24 travel, as shown in FIG. 7.

The door panel 12 is pivotally and attached at its bottom 22 and top 24 to the lower and upper door guides 14, 14′, respectively. The pivot points of the door panel 12 and door guides 14, 14′ together define a pivot axis 100 about which the door panel 12 pivots. The door panel 12 is pivotally attached to the lower and upper door guides 14, 14′ mid-span along its length such that the entirety of the length of the door is not required to be received in the room when in the fully open position, and a short length of the door can protrude outward beyond the door opening in the fully open position. The door panel 12 can be pivotally attached to the first pair of door guides 14, 14′, for example, about midway between the center and the free end of the door panel 12.

The weight of the door panel 12 can be cooperatively supported by the lower and upper door guides 14, 14′, with the majority of the weight of the door panel 12 being supported by the upper door guide 14′ by suspension therefrom. The upper door guide 14′ can be embedded within the top of the doorframe in a lavatory wall as shown in FIG. 7.

The second pair of linear door guides 16, 16′ run parallel along the adjacent wall 18. The second pair of linear door guides 16, 16′ include a lower door guide 16 and an upper door guide 16′. The lower and upper door guides 16, 16′ are in spaced vertical alignment. The lower door guide 16 can be located on the adjacent wall 18 at or near floor level. The upper door guide 16′ can be located on the adjacent wall 18 at or near ceiling level. The door panel 12 can be hinged and slidably attached to the second pair of door guides 16, 16′ along one side 28 thereof such that movement of side 28 is cooperatively guided by the second pair of door guides 16, 16′.

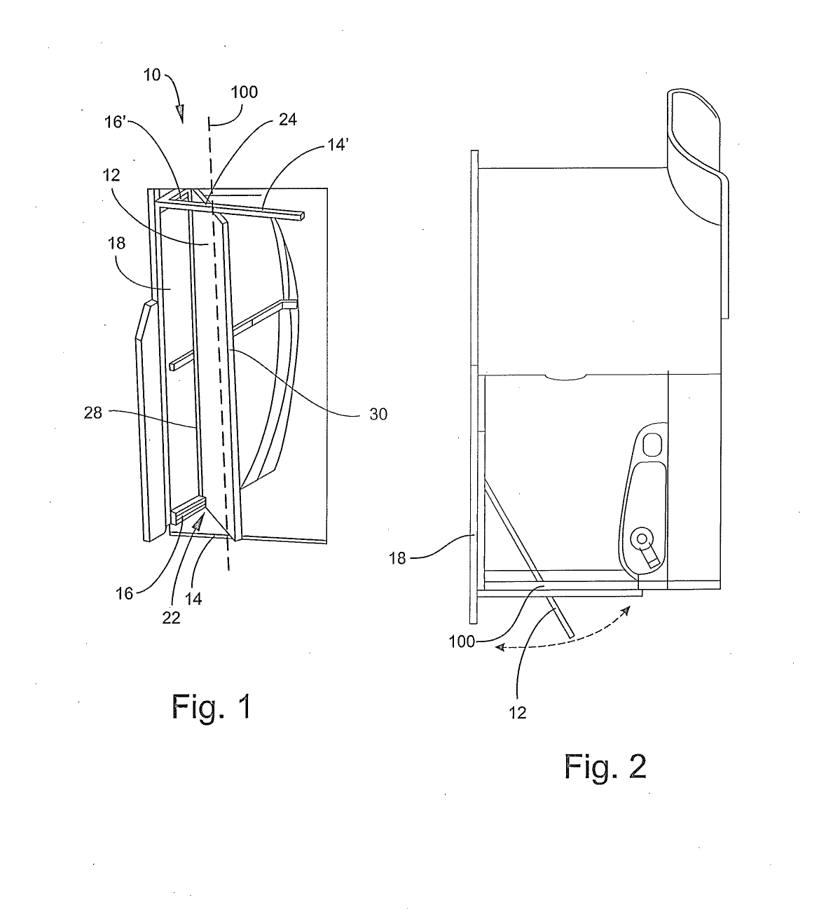

When moved from a closed to an open position, the free side 30 of door panel 12 moves outward slightly relative to the door opening and in the direction of the adjacent wall 18, while the hinged side 28 of the door panel 12 moves rearward along the adjacent wall 18. The opposite occurs when closing the door panel 12. In the fully open position, the exterior face of the door panel 12 faces the adjacent wall 18 and can be arranged substantially parallel thereto. As shown in FIG. 2, in a partially open position it can be seen that the door panel 12 requires only a small portion of the interior of the room for clearance, allowing great latitude in the amount and placement of furniture and fixtures within the room, for example the lavatory sink as shown in FIG. 2. In contrast to conventional swinging doors that require a large amount if either internal or external clearance for the full length of the door, the door assembly of the present invention requires a minimal amount of internal and external clearance.

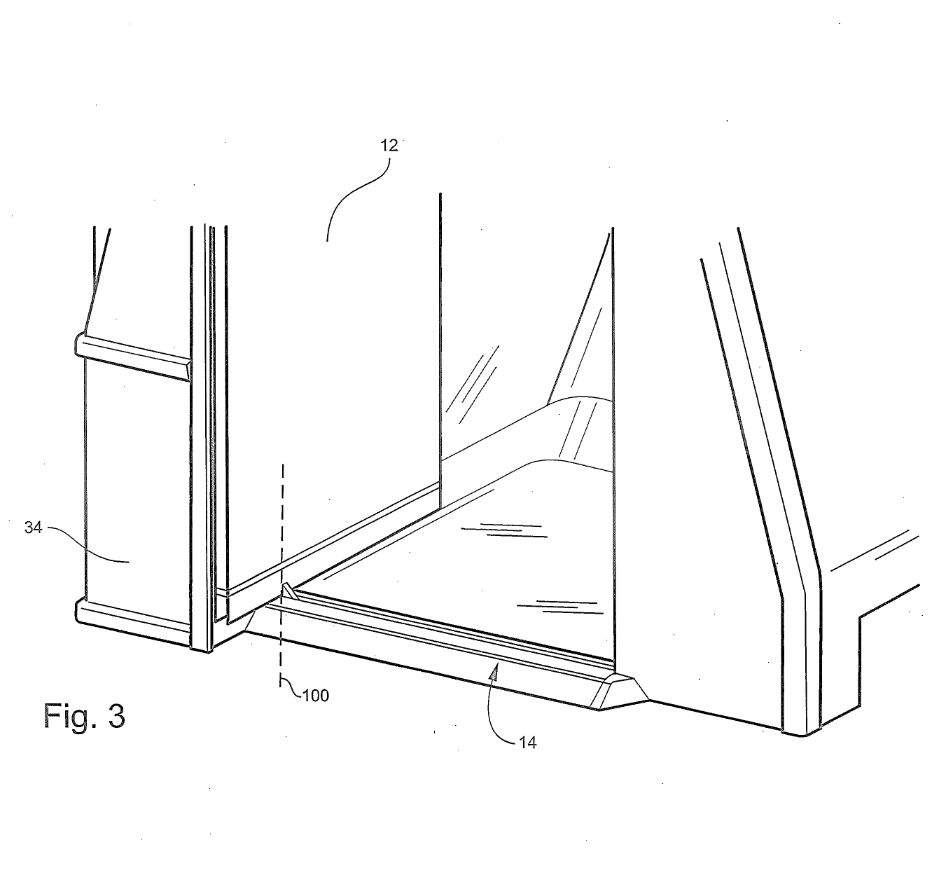

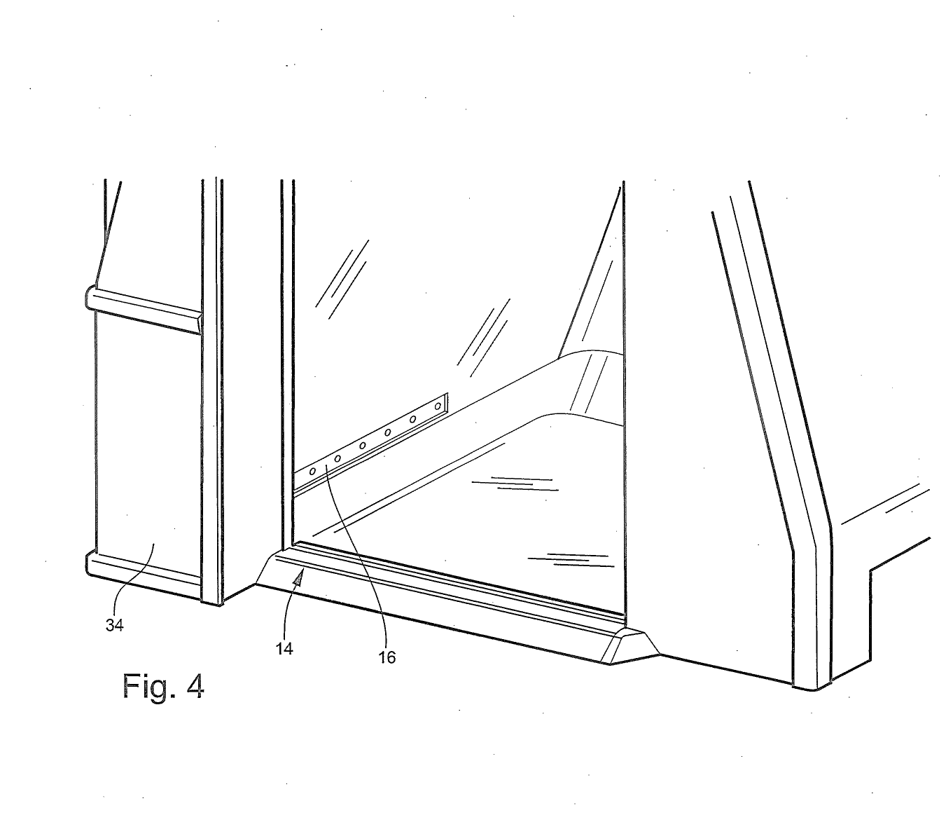

Any of the first and second pairs of linear door guides 14, 14′, 16, 16′ can be embedded within a lavatory or other supporting wall to conceal and protect the door guides and maximize the use of interior space. Referring to FIGS. 3-5, at least the lower door guide 14 can be partially concealed beneath a cover to keep its track free from dirt, debris and damage. The cover can have a gradual angle to transition the protrusion of the lower door guide 14 from the floor for safety.

In another embodiment, an aircraft lavatory accessible through a door opening and including the door assembly 10 is provided herein. The free side 30 of the door panel 12 protrudes outward beyond the door opening, but does not protrude outward beyond the face of an attendant wall 34 when the door panel 12 is fully open. The door assembly 10 includes the features of and operates as described above.

The door assembly 10 can include shafts, pins or like structure that engage tracks of the linear door guides 14, 14′, 16, 16′ and allow the door panel 12 to pivot with respect to the tracks as the door slides between its open and closed positions. In one example, the door panel 12 includes fours shafts extending therefrom, with each shaft being received within one of the door guides 14, 14′, 16, 16′. Although the door panel 12 can pivot upon shafts, the door assembly 10 can include other structure that allows the door panel 12 to pivot and slide with respect to the door guides 14, 14′, 16, 16′.

As the door panel 12 moves from a closed position to an open position, the shafts or other structure of the hinged side 28 of the door panel 12 travel within their respective door guides 16, 16′ in the direction away from the door opening, such as perpendicular thereto, while the other shafts or like structure inward of the free side 30 of the door panel 12 simultaneously travel within their respective door guides 14, 14′ in the direction of the second pair of door guides 16, 16′. The arrangement of the four pivot points of the door panel 12 generally forms a parallelogram that can maintain its shape and allows the door to operate in the event of flexure of the room walls.

The door panel 12 can be opened from the exterior of the room by pulling a door handle 32 outward and/or in the direction of the adjacent wall 18. The door panel 12 may also be opened by pulling outward on the door handle 32 with one hand while simultaneously pushing in on the door adjacent the hinged side 28 with the other hand. The door panel 12 may be opened from the interior of the room by pushing the door handle 32 out and/or in the direction of the adjacent wall 18. The door assembly 10 may be configured to open to the left or to the right. Mechanisms known to those skilled in the art can be added to the door assembly 10 for self-opening and self-closing assistance. The door handle 32 and corresponding latch 36 may be magnetic or otherwise configured to assist in the final closing of the door panel 12. The door latch 36 may utilize a double acting lock mechanism. Latch and lock mechanisms may be integral to the door slab.

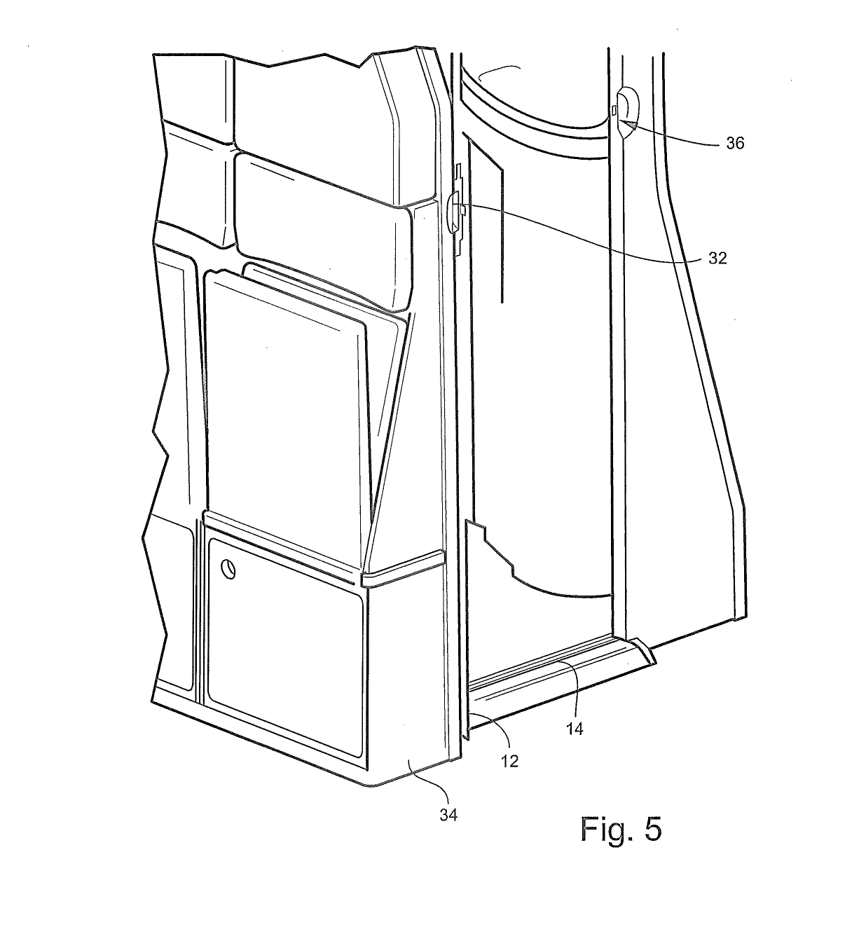

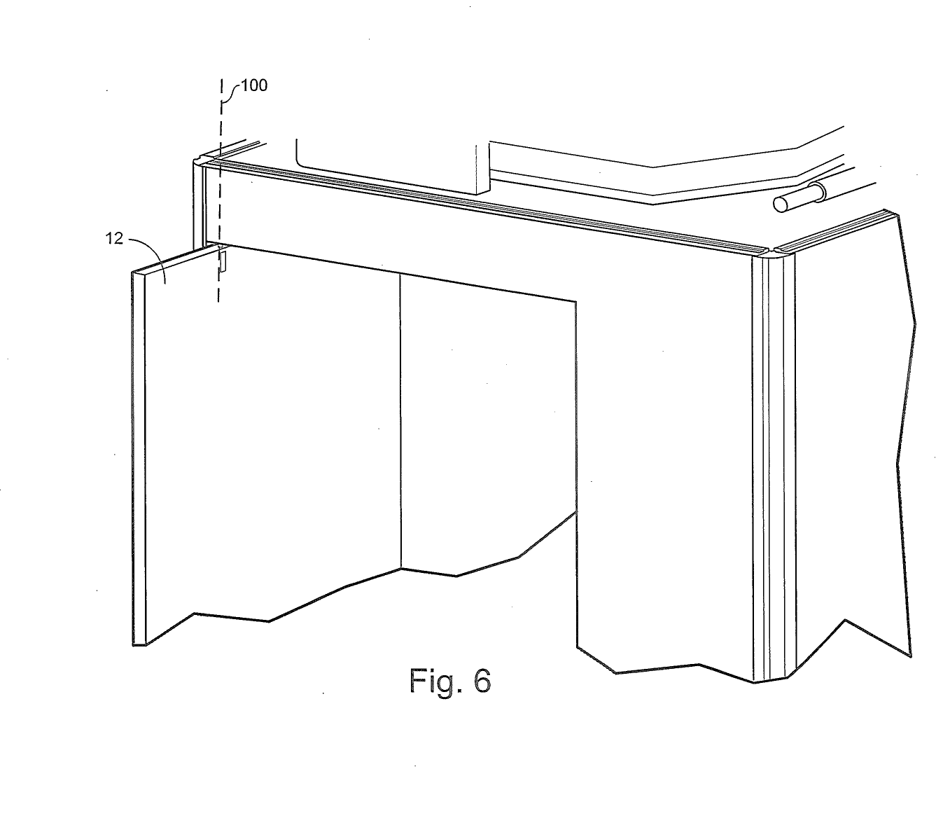

The maximum protrusion distance of the door panel 12 with respect to the door opening occurs at the fully open position. As shown in FIG. 5, the door panel 12 does not protrude beyond the face of the attendant wall 34. Thus, an opposing lavatory door or monument can be accessed simultaneously without door collision. Additionally, egress into the opposing lavatories is not affected. In a specific embodiment, with the door panel 12 in the fully open position, consumption of less than about ⅝″ intrusion into the passenger entry/exit space from the attendant wall 34 can be achieved, in comparison to a typical bi-fold door that consumes about 3″.

The door panel 12 may be constructed from a single panel or a plurality of panels. In one example, the door panel 12 is about ½″ thick. The door panel 12 may utilize a calculated decompression gap. The door guides 14, 14′, 16, 16′ may include replaceable polymer sliding elements that are maintenance-free, self-lubricating and have a low coefficient of friction for ease of use and smooth movement.

While a passenger aircraft interior door assembly has been described with reference to specific embodiments and examples, it is intended that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. An aircraft interior door assembly, comprising:
a door panel configured to simultaneously pivot and translate within a door opening;
a first pair of linear door guides running parallel to the door opening for guiding pivoting and translational movement of the door panel relative to the door opening, the door panel being pivotally attached to the first pair of linear door guides mid-span along the length of the door panel; and
a second pair of linear door guides running along an adjacent wall at an angle to the door opening for guiding an attached side of the door panel along the adjacent wall.

2. The aircraft interior door assembly according to claim 1, wherein one linear door guide of each of the first and second pairs of linear door guides is located at or near the top of the door panel, and the other linear door guide of the first and second pairs of linear door guides is located at or near the bottom of the door panel.

3. The aircraft interior door assembly according to claim 1, wherein the first pair of linear door guides are in vertically spaced apart alignment.

4. The aircraft interior door assembly according to claim 1, wherein the second pair of linear door guides are in vertically spaced apart alignment.

5. The aircraft interior door assembly according to claim 1, wherein at least one of the linear door guides of the first and second pairs of linear door guides are embedded within an interior wall panel.

7. The aircraft interior door assembly according to claim 1, wherein attachment points of the door panel to the first pair of linear door guides defines a pivot axis through the door panel parallel to its longitudinal axis about which the door panel pivots when opened or closed.

8. The aircraft interior door assembly according to claim 1, wherein each of the linear door guides of each of the first and second pairs of linear door guides includes a door panel attachment member that travels linearly within a guide track.

9. The aircraft interior door assembly according to claim 1, wherein the adjacent wall is perpendicular to the door opening such that the first pair of linear door guides are arranged perpendicular to the second pair of linear door guides.

10. The aircraft interior door assembly according to claim 1, wherein the door opening is a door opening of an aircraft lavatory and the adjacent wall is an attendant wall, and wherein a free side of the door panel protrudes outward beyond the door opening but does not protrude outward beyond a face of the attendant wall when the door panel is fully open.

11. An aircraft lavatory accessible through a door opening, the door opening including a door assembly comprising:
a door panel configured to simultaneously pivot and translate within the door opening;
a first pair of linear door guides running parallel to the door opening for guiding pivoting and translational movement of the door panel within the door opening, the door panel being pivotally attached to the first pair of linear door guides mid-span along the length of the door panel; and
a second pair of linear door guides running along a lavatory wall adjacent the door opening and at an angle thereto for guiding a side of the door panel along the lavatory wall within the lavatory, the side of the door panel guided along the lavatory wall being attached to and slidable relative to the second pair of linear door guides.

12. The aircraft lavatory according to claim 11, wherein one linear door guide of each of the first and second pairs of linear door guides is located at or near the top of the door panel, and the other linear door guide of the first and second pairs of linear door guides is located at or near the bottom of the door panel.

13. The aircraft lavatory according to claim 11, wherein the first pair of linear door guides are in vertically spaced apart alignment.

14. The aircraft lavatory according to claim 11, wherein the second pair of linear door guides are in vertically spaced apart alignment.

15. The aircraft lavatory according to claim 11, wherein at least one of the linear door guides of the first and second pairs of linear door guides are embedded within a lavatory wall.

16. The aircraft lavatory according to claim 11, 1, wherein pivot points of the top and bottom of the door panel and the first pair of linear door guides are in vertical alignment.

17. The aircraft lavatory according to claim 11, wherein each of the linear door guides of each of the first and second pairs of linear door guides includes a door panel attachment member that travels linearly within a guide track.

18. An aircraft interior door assembly, comprising:
a door panel configured to simultaneously pivot and translate within its door opening;
a first pair of linear door guides running parallel to the door opening for guiding pivoting and translational movement of the door panel, the door panel being pivotally attached to the first pair of linear door guides mid-span along its length; and
a second pair of linear door guides running along an adjacent wall perpendicular to the door opening, the second pair of linear door guides guiding movement of an attached side of the door panel along the adjacent wall.

19. The aircraft interior door assembly according to claim 18, wherein one linear door guide of each of the first and second pairs of linear door guides is located at or near the top of the door panel, and the other linear door guide of the first and second pairs of linear door guides is located at or near the bottom of the door panel.
